(19) United States
(12) Patent Application Publication
(10) Pub. No.: US 2003/0195871 A1
(43) Pub. Date: Oct. 16, 2003

(54) General platform and method for querying of intellectual property information

(76) Inventors: Cai-Yang Luo, Shenzhen (CN); Xiu-Ming Duan, Shenzhen (CN); Chung-I Lee, Tu-Chen (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/176,815

(22) Filed: Jun. 20, 2002

(30) Foreign Application Priority Data
Apr. 12, 2002 (TW) 91107524

(51) Int. Cl. G06F 17/30

(52) U.S. Cl. 707/3

(57) ABSTRACT

A general query platform and method for querying of intellectual property information. The general query platform (100) includes a user interface (110) for inputting of a query (11) in a first format; a query processor (120) for changing the first format query into a second format query that intellectual property information websites (13) can identify; and an intellectual property information download unit (130) for transmitting the second format query to databases of the intellectual property information websites, converting information returned from the websites into the first format, and transmitting the first format returned information to the user interface. The query processor further includes an XML changing module (121) for changing the first format query into an XML format query, and an HTTP changing module (122) for changing the XML format query into an HTTP format query that intellectual property information websites can identify.

### BACKGROUND OF THE INVENTION

1. Field of the Invention

The present invention relates to a general platform and method for electronic querying of intellectual property information, and particularly to a platform and method for changing a first format query of users into other format queries that various intellectual property information websites can identify.

2. Background of the Invention

With the development of electronic communications networks, information can be exchanged and used more efficiently than ever. With a client computer connected to a network, a user can access all kinds of information available on the network. A standard method for searching for information on a network is: logging on a private or public network; inputting key words related to the information in a specific query format of the network via an interface of the network; and acquiring the information needed.

Recently, query technology for information on a network has developed quickly. U.S. Pat. No. 6,085,186 discloses a network robot that can assist a user to search for information on a network. The network robot can track available network information sources, and ascertain the relevant information and features of each particular source. When the user sends a query to the robot, the robot determines which sources are relevant to the given query, forwards the query to the most relevant information sources, receives the responses returned from each source, and integrates and intelligently presents the query results to the user.

FIG. 5 shows a query system as disclosed in U.S. Pat. No. 6,085,186. A network robot 500 mainly comprises a user interface 510, an integrator 520, and an input/output (I/O) manager 530. When a query 51 is input from the user interface 510, a query router 521 in the integrator 520 receives the query 51 and determines information sources related to the query. An aggregation engine 523 in the integrator 520 formats the query 51 according to a description of each relevant information source in a wrapper database 522. The I/O manager 530 transmits the formatted query to each of the relevant information sources 53. After receiving responses returned from the relevant information sources 53, the I/O manager 530 forwards the responses to the aggregation engine 523, which then extracts data from the responses relevant to the query 51. Finally, the user interface 510 presents the extracted data 52 to the user.

However, when this query system is used to search intellectual property (IP) information, the data finally received may not meet the user's requirements. The IP information can only be queried on private IP information websites, by the use of search engines thereof. In many instances, when a user queries IP information by inputting keywords, most of the information returned from the query system is not IP information. Instead, the returned information merely comprises the keywords themselves.

In addition, when the user wants to query IP information, he/she must log on a specific IP information website which provides the IP information needed. The IP information may, for example, be patent information. If the user wants to query another kind of IP information, he/she must log on another IP information website. Such other kind of IP information may, for example, be trademark information. Individual logging on multiple websites is unduly time consuming. Furthermore, each IP information website respectively has its own particular query format. The user must know the various query formats of different IP information websites. All the above-mentioned difficulties cause inconvenience, delay and confusion.

### SUMMARY OF THE INVENTION

Accordingly, it is a general object of the present invention to provide a system and method for querying of intellectual property (IP) information which provides a general user interface from which a user can query IP information at various IP information websites.

It is another object of the present invention to provide a system and method for querying of IP information which can transform a first format query input by users into a second format query that can be identified by various IP information websites.

In order to accomplish the above-mentioned objects, the present invention provides a general query platform used for querying of IP information. The platform comprises: a user interface for receiving a query in a first format input by a user, the first format query comprising keywords related to the IP information and a website identified as providing the IP information; a query processor for changing the first format query into an HTTP format query, which can be identified by the website; and an IP information download unit for transmitting the HTTP format query to the website, converting information returned from the website into the first format, and transmitting the first format returned information to the user interface.

Furthermore, the present invention provides a general query method used for querying of IP information, the method comprising the following steps: (i) receiving a query in a first format input by a user, the first format query comprising keywords related to the IP information and a website identified as providing the IP information; (ii) changing the first format query into an XML format query; (iii) changing the XML format query into an HTTP format query; (iv) transmitting the HTTP format query to the website; (v) converting information returned from the website into the first format; and (vi) presenting the first format returned information to the user.

Other objects, advantages and novel features of the present invention will be drawn from the following detailed description of preferred embodiments of the present invention with the attached drawings, in which:

### BRIEF DESCRIPTION OF THE DRAWINGS

FIG. 1 is a schematic diagram of infrastructure of an intellectual property (IP) information query platform in accordance with a preferred embodiment of the present invention;

FIG. 2 illustrates a user interface for inputting a query in accordance with the preferred embodiment of the present invention;

FIG. 3 illustrates a user interface for displaying information obtained from IP information websites, in accordance with the preferred embodiment of the present invention;

FIG. 4 is a flow chart of querying IP information in accordance with a preferred embodiment of the present invention; and

FIG. 5 is a schematic diagram of infrastructure of a conventional system for querying information.

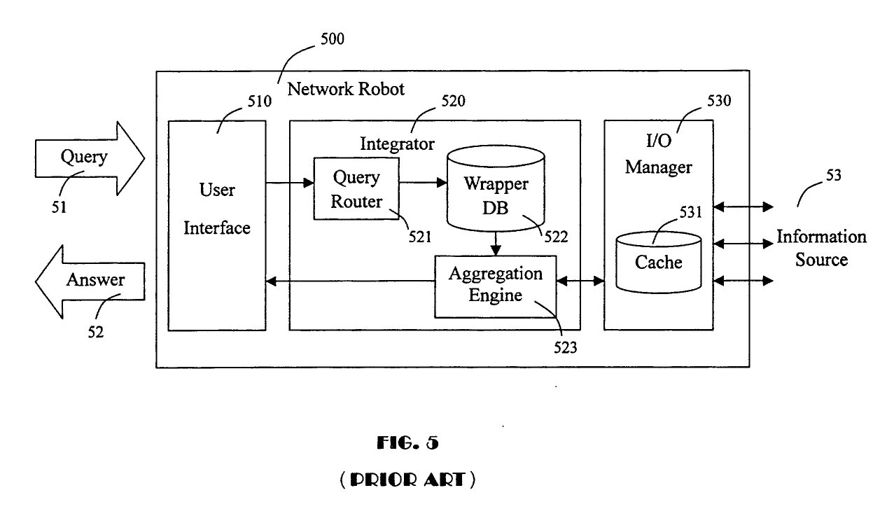

### DETAILED DESCRIPTION OF PREFERRED EMBODIMENTS OF THE INVENTION

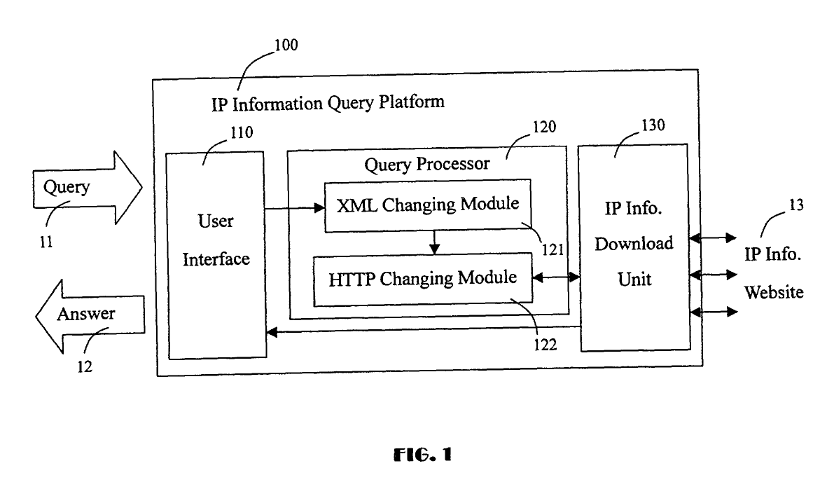

FIG. 1 is a schematic diagram of infrastructure of an intellectual property (IP) information query platform 100 in accordance with a preferred embodiment of the present invention, which can support the method of the disclosed subject matter. The IP information query platform 100 comprises a user interface 110, a query processor 120, and an IP information download unit 130. The user interface 110 allows users to input a query 11. The query processor 120 comprises an Extensible Markup Language (XML) changing module 121, and a HyperText Transfer Protocol (HTTP) changing module 122. The XML changing module 121 is used for converting the query 11 into an XML format query. The HTTP changing module 122 is used for changing the XML format query into an HTTP format query, which can be identified by IP information websites 13. The IP information download unit 130 can transmit the HTTP format query to databases of the IP information websites 13, and change IP information obtained from the IP information websites 13 into information that can be identified by users. The user interface 110 presents such information to the users.

In an alternative embodiment of the present invention, the query processor 120 comprises only one format changing module; that is, the HTTP changing module 122. The HTTP changing module 122 can change the query 11 into an HTTP format query, which can be identified by the IP information websites 13.

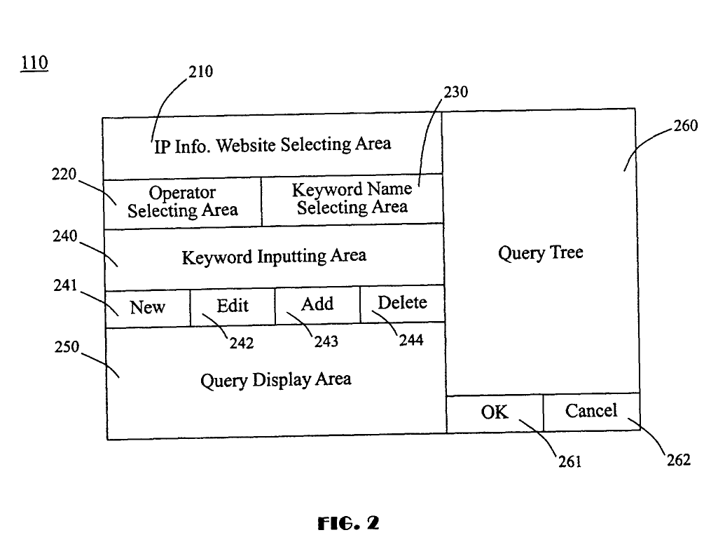

FIG. 2 illustrates the user interface 110 for inputting a query, in accordance with the preferred embodiment of the present invention. An IP information website selecting area 210 is used for selecting an IP information website at which IP information is to be searched. The IP information website may typically be selected from one of the following: the website of the United States Patent And Trademark Office (USPTO), the website of the State Intellectual Property Office of the People's Republic of China (P.R.C.), the website of the Japanese Patent Office, and the website of the European Patent Office. The se websites provide IP information such as patent information and trademark information. An operator selecting area 220 is used for ascertaining a logic relationship between input keywords, such as ‘and,’ ‘or,’ and ‘andnot.’ A keyword name selecting area 230 is used for selecting names of the input keywords, such as patent number, patent name, and assignee. A keyword inputting area 240 is used for inputting keywords according to the keyword name selected in the keyword name selecting area 230. A ‘New’ button 241 is used for initiating a keyword input process. A user clicks the ‘New’ button 241 before he/she inputs new keywords. An ‘Edit’ button 242 is used to modify an input keyword. When the user wants to modify an input keyword, he/she first clicks the ‘Edit’ button 242. After inputting a new keyword, the user clicks an ‘Add’ button 243. If the user wants to delete an input keyword, he/she can click a ‘Delete’ button 244.

A query display area 250 is used for displaying a query of the user in accordance with the selected operators, the keyword names and the input keywords. A query tree 260 can display the query in a tree format. After inputting all keywords of the query, the user can click an ‘OK’ button 261 to start searching for IP information. The user can also click a ‘Cancel’ button 262 to stop searching for IP information.

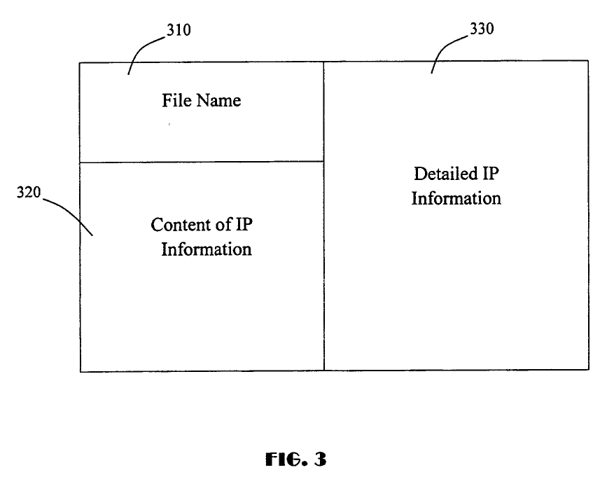

FIG. 3 illustrates a user interface for displaying information obtained from IP information websites, in accordance with the preferred embodiment of the present invention. File name 310 is used for displaying a name of an electronic file that contains information obtained from the selected IP information website. Content of IP information 320 is used to display a catalog of the information obtained from the selected IP information website. For example, if the information obtained from the selected IP information website is patent information, the content of IP information 320 may show patent numbers of patents in the patent information. Detailed IP information 330 is used for displaying details of the information obtained from the selected IP information website. For example, the details may be image information or text information of patents in the patent information.

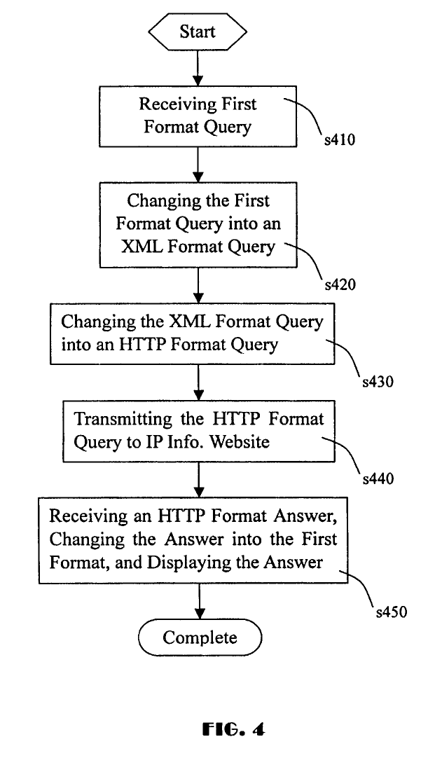

FIG. 4 is a flow chart of querying IP information, in accordance with a preferred embodiment of the present invention. First, the query processor 120 receives the query 11 that the user input from the user interface 110 (step s410). For example, the user may want to query patents owned by Motorola which were filed in the USPTO, which issued between Jul. 7, 2001 and Dec. 31, 2001, and which are classified as G06F according to patent International Classification codes. After the user inputs the query at the user interface 110, a tree of the query 11 is displayed in the query tree 260 as follows:

| And | |
|---|---|
| [symbol] | And |

Issue Date/2001/07/01->2001/12/31
International Classification/G06F

Assignee Name/Motorola

The input query is in a first format which can be identified and understood by the user. After receiving the query 11, the query processor 220 changes the query 11 into an XML format query (step s420). In step s420, the XML changing module 121 runs the following first program:

Private Function ThroughTreeWithxml(objnode As Node) As String

Dim xmlTree As String
Dim strValue As String
Dim strField As String
Dim vp As Integer
If objnode.children = 0 Then

If InStr(1, objnode.Text, strFieldName_Assignee_JP, vbTextCompare) = 0 Then

vp = InStr(1, objnode.Text, ″/″, vbTextCompare)
If vp <> 0 Then

strField = objCon.PtoFN_P2L(m_curPto, Mid(objnode.Text, 1, vp − 1))
If strField <> ″″ Then

strValue = Mid(objnode.Text, vp + 1)

Else

strValue = objnode.Text

End If

Else

strValue = objnode.Text

End If

Else

strField = objCon.PtoFN_P2L(m_curPto, strFieldName_Assignee_JP)
vp = InStr(Len(strFieldName_Assignee_JP), objnode.Text, ″/″, vbTextCompare)
strValue = Mid(objnode.Text, vp + 1)

End If
strValue = Replace(strValue, ″″″″, ″%22″, , , vbTextCompare)
strField = Replace(strField, ″″″″, ″%22″, , , vbTextCompare)
xmlTree = ″<node type=″″key″″ value=″″″ & strValue & ″″″ field=″″″ & strField & ″″″/>″

Else

ThroughTreeWithxml(objnode.Child.FirstSibling) & ThroughTreeWithxml(objnode.Child.LastSibling) &

″</node>″

If objnode.Child.FirstSibling.Index <> objnode.Child.LastSibling.Index Then

xmlTree = ″<node type=″″operation″″ value=″″″ & objnode.Text & ″″″>″ &

ThroughTreeWithxml(objnode.Child.FirstSibling) & ThroughTreeWithxml(objnode.Child.LastSibling) &
″</node>″

Else

xmlTree = ″<node type=″″operation″″ value=″″″ & objnode.Text & ″″″>″ &

ThroughTreeWithxml(objnode.Child.FirstSibling) & ″<node>″

End If

End If
ThroughTreeWithxml = xmlTree

End Function

After the program is executed, the query 11 is changed into the following XML format query:

-<condition country=“us” patentamount=“0” lastsearchdate=“” createdate=“Mar. 3, 2002 10:09:09”

id=“27”>

-<node type=“operator” value=“And”>

-<node type=“operator” value=“And”>

<node type=“key” value=“motorola” field=“73” />

<node type=“key” value=“g06f$” field=“51” />

</node>

<node type=“key” value=“Jul. 7, 2001->Dec. 31, 2001” field=“45” />

</node>

-<property>

<pseudocode/>

<description/>

</property>

<Lost/>

</condition>

Then the XML format query is changed into an HTTP format query by the HTTP changing module 122 (step s430). In the preferred embodiment of the present invention, the HTTP format query can be identified by the website of the USPTO. The HTTP changing module 122 enumerates the XML format query, and changes the XML format query into an HTTP format query by running the following second program:

Private Function TransCondition(Optional ByVal xmlCon As String) As String

Dim oxml As DOMDocument30
Dim oNode As IXMLDOMNode
Dim oRoot As IXMLDOMNode
Dim oEle As IXMLDOMElement
Dim oList As IXMLDOMNodeList
Dim strCondition As String
Set oxml = CreateObject(″Msxml2.DOMDocument″)
oxml.async = False
oxml.loadXML xmlCon
Set oList = oxml.getElementsByTagName(″condition″)
If oList.length = 0 Then

Set oList = oxml.getElementsByTagName(″node″)
If oList.length = 0 Then

TransCondition = ″″
Exit Function

Else

Set oRoot = oList.Item(0)

End If

Else

For Each oNode In oList

If LCase(oNode.Attributes.getNamedItem(″country″).Text) = ″us″ Then

Set oRoot = oNode.firstChild

End If

Next

End If

′===================================

strCondition = ThroughNode(oRoot)
TransCondition = strCondition

End Function
Private Function ThroughNode(ByRef xmlNode As IXMLDOMNode) AsString

Dim strResult As String
Dim strFname As String
Dim strFvalue As String
Dim strType As String
strResult = ″″: strFname= ″″: strFvalue = ″″: strType = ″″
If xmlNode Is Nothing then ThroughNode = ″″: Exit Function
strType = xmlNode.Attributes.getNamedItem(″type″).Text: strType = LCase(strType)
If strType = ″operation″ Then

If xmlNode.childNodes.length = 0 Then

ThroughNode = ″″

Else

strResult =″(″
strResult = strResult & ThroughNode(xmlNode.firstChild)
strResult = strResult & Space(3)
strResult = strResult & xmlNode.Attributes.getNamedItem(″value″).Text
strResult = strResult & Space(3)
strResult = strResult & ThroughNode(xmlNode.lastChild)
strResult = strResult & ″)″
ThroughNode = strResult

End If

End If
If strType = ″key″ Then

strFname = xmlNode.Attributes.getNamedItem(″field″).Text
strFvalue = xmlNode.Attributes.getNamedItem(″value″).Text
If strFname <> ″″ Then

strFname = MatchFieldName(strFname)
strFvalue = Trim(strFvalue)
strResult = Trans_QuoteProc(strFname, strFvalue)

If strFname = ″ISD″ Or strFname = ″APD″ Then
strFvalue = Trans_DateInput(strFvalue)
strResult = strFname & ″/″ & strFvalue

End If
ThroughNode = strResult

Else
‘-----When the Field Name is Null -------The Condition Input mode is as same as ″ICM&A1.1″----

strResult = Trans QuoteProc(strFname, strFvalue)
ThroughNode = strResult

End If

End If

End Function
Private Function Trans_QuoteProc(ByVal FieldName As String, ByVal FieldValue As String) As String

Dim strResult As String
Dim strFvalue As String
strFvalue = FieldValue
If FieldName <> ″″ Then ‘------------Field Name is not Null-------------

If InStr(1, FieldValue, ″ ″, vbTextCompare) <> 0 Then

If Not (Left(FieldValue, 1) = ″″″ and right(FieldValue,1)=″″″) Then

If Not (Left(FieldValue, 3) = ″%22″ And Right(FieldValue, 3) = ″%22″) Then

If Not (Left(FieldValue, 1) = ″(″ And Right(FieldValue, 1) = ″)″) Then

If InStr(1, FieldValue, ″ AND ″, vbTextCompare) <> 0 Or _{—}

InStr(1, FieldValue, ″ OR ″, vbTextCompare) <> Or _{—}
InStr(1, FieldValue, ″ ANDNOT ″, vbTextCompare) <> 0 Then

strFvalue = ″(″ & FieldValue & ″)″

Else

strFvalue = Chr(34) & FieldValue & Chr(34)

End If

End If

End If

End If

Else

strFvalue = FieldValue

End If
strResult = FieldName & ″/″ & strFvalue

Else ‘-------------------------------------Field Name is Null-------------------

strResult = FieldValue

End If
Trans_QuoteProc = strResult

End Function
Private Function Trans_DateInput(ByVal Data As String) As String

Dim strDate As String
strDate = Data
If Not IsDate(strDate) Then

If InStr(1, strDate, ″$″, vbTextCompare) <> 0 Then

If IsNumeric(Left(strDate, 4)) Then

If Mid(strDate, 5, 2) <> ″/$″ Then

strDate = Mid(strDate, 6) & ″/″ & Left(strDate, 4)

Else

strDate = Left(strDate, 4) & ″0101->″ & Left(strDate, 4) & ″1231″

End If

End If

End If
If InStr(1, strDate, ″->″, vbTextCompare) <> 0 Then

strDate = Replace(strDate, ″/″, ″″, , , vbTextCompare)

End If

Else

strDate = Format(strDate, ″MM/dd/yyyy″)

End If
Trans_DateInput = strDate

End Function
Private Function MatchFieldName(ByVal vData As String) As String

Select Case vData

Case ″11″: MatchFieldName = ″PN″
Case ″54″: MatchFieldName = ″TTL″
Case ″57″: MatchFieldName = ″ABST″
Case ″51″: MatchFieldName = ″ICL″
Case ″E51″: MatchFieldName = ″″
Case ″21″: MatchFieldName = ″APN″
Case ″22″: MatchFieldName = ″APD″
Case ″O11″: MatchFieldName = ″″
Case ″43″: MatchFieldName = ″″
Case ″P11″: MatchFieldName = ″″
Case ″45″: MatchFieldName = ″ISD″
Case ″86″: MatchFieldName = ″″
Case ″D86″: MatchFieldName = ″″
Case ″87″: MatchFieldName = ″″
Case ″D87″: MatchFieldName = ″″
Case ″85″: MatchFieldName = ″″
Case ″73″: MatchFieldName = ″AN″
Case ″AC″: MatchFieldName = ″AC″
Case ″AS″: MatchFieldName = ″AS″
Case ″CAN″: MatchFieldName = ″ACN″
Case ″ACN″: MatchFieldName = ″ACN″
Case ″72″: MatchFieldName = ″IN″
Case ″IC″: MatchFieldName = ″IC″
Case ″IS″: MatchFieldName = ″IS″
Case ″ICN″: MatchFieldName = ″ICN″
Case ″74″: MatchFieldName = ″LREP″
Case ″DL″: MatchFieldName = ″LREP″
Case ″FA″: MatchFieldName = ″″
Case ″BZ″: MatchFieldName = ″″
Case ″30″: MatchFieldName = ″″
Case ″EXP″: MatchFieldName = ″EXP″
Case ″EXA″: MatchFieldName = ″EXA″
Case ″52″: MatchFieldName = ″CCL″
Case ″APT″: MatchFieldName = ″APT″
Case ″REF″: MatchFieldName = ″REF″
Case ″FREF″: MatchFieldName = ″FREF″
Case ″OREF″: MatchFieldName = ″OREF″
Case ″GOVT″: MatchFieldName = ″GOVT″
Case ″PARN″: MatchFieldName = ″PARN″
Case ″PCT″: MatchFieldName = ″PCT″
Case ″ACLM″: MatchFieldName = ″ACLM″
Case ″REIS″: MatchFieldName = ″REIS″
Case ″SPEC″: MatchFieldName = ″SPEC″
Case ″PRIR″: MatchFieldName = ″PRIR″
Case ″RLAP″: MatchFieldName = ″RLAP″
Case Else

MatchFieldName = vData

End Select

End Function

After the program is executed, the XML format query is changed into the following HTTP format query:

http://164.195.100.11/netacgi/nph-Parser?Sect1=PTO2&

Sect2=HITOFF&

u=%2Fnethtml%2Fsearch%2Dadv%2Ehtm&

r=0&

p=1&

f=s&

l=50&

Query=%28%28AN%2Fmotorola+And+ICL%2Fh011%24%29+And+ISD%2F20010701%2D%3E20011231%29&

d=pall

The code ‘http://164.195.100.11’ is the IP address of the website of the USPTO.

Then the HTTP format query is transmitted to the IP information website 23 by the IP information download unit 130 (step s440). In the preferred embodiment of the present invention, the IP information website 23 can be the website of the USPTO.

After receiving the HTTP format query, the website of the USPTO returns information according to the query. The returned information is in HTTP format. The IP information download unit 130 receives the returned information and changes the HTTP format returned information into first format returned information (step s450). Finally, the user interface 110 presents the first format returned information to the user. The user can browse the first format returned information via the user interface 110, or save the first format returned information to a local disk.

Although only preferred embodiments of the present invention have been described in detail above, those skilled in the art will readily appreciate that many modifications to the preferred embodiments are possible without materially departing from the novel teachings and advantages of the present invention. Accordingly, all such modifications are deemed to be covered by the following claims and allowable equivalents of the claims.

What is claimed is:

1. A general query platform for querying of intellectual property information, the platform comprising:
a user interface for receiving a query in a first format input by a user, the first format query comprising at least one keyword related to the intellectual property information and at least one website identified as providing the intellectual property information;
a query processor for changing the first format query into a second format query that can be identified by the at least one website; and
an intellectual property information download unit for transmitting the second format query to the at least one website, converting information returned from the at least one website into the first format, and transmitting the first format returned information to the user interface.

2. The general query platform as claimed in claim 1, wherein the query processor further comprises an XML changing module for changing the first format query into an XML format query.

3. The general query platform as claimed in claim 2, wherein the query processor further comprises an HTTP changing module for changing the XML format query into an HTTP format query.

4. The general query platform as claimed in claim 1, wherein the information returned from the at least one website comprises patent information.

5. The general query platform as claimed in claim 1, wherein the information returned from the at least one website comprises trademark information.

6. A general query method for querying of intellectual property information, the method comprising the steps of:
receiving a query in a first format input by a user, the first format query comprising at least one keyword related to the intellectual property information and at least one website identified as providing the intellectual property information;
changing the first format query into an XML format query;
changing the XML format query into an HTTP format query;
transmitting the HTTP format query to the at least one website;
converting information returned from the at least one website into the first format; and
presenting the first format returned information to the user.

7. A general query method for querying of intellectual property information, the method comprising the steps of:
receiving a query in a first format input by a user, the first format query comprising at least one keyword related to the intellectual property information and at least one website identified as providing the intellectual property information;
changing the first format query into an HTTP format query which can be identified by the at least one website;
transmitting the HTTP format query to the at least one website;
converting information returned from the at least one website into the first format; and
presenting the first format returned information to the user.

8. The general query method as claimed in claim 7, wherein the step of changing the first format query into an HTTP format query which can be identified by the at least one website further comprises the steps of:
changing the first format query into an XML format query; and
changing the XML format query into the HTTP format query.

9. A general query method comprising the steps of:
providing a query platform which is accessible by a user via a user interface using a first input format;
linking the query platform to a plurality of information source websites which are internally searchable by using other input formats, some of which are different from the first input format;
equipping said query platform with capabilities of converting said first input format and said other input formats with each other; wherein
said platform receives a specific query including information requirements and a corresponding website identification;
said platform further converts the first input format to a selective second input format recognized by said selected identified website;
said platform sends the query to the corresponding website and runs a search thereon directly using the second input format;
said platform obtains results from the corresponding website; and
said platform sends said results to the use by using the first input format.
